(19) United States
(12) Patent Application Publication
(10) Pub. No.: US 2013/0278893 A1
(43) Pub. Date: Oct. 24, 2013

(54) MULTI WAVELENGTH LASER PROTECTIVE EYEWEAR

(71) Applicants: Eric Lemay, Laguna Niguel, CA (US); Benjamin George Phipps, Long Beach, CA (US)

(72) Inventors: Eric Lemay, Laguna Niguel, CA (US); Benjamin George Phipps, Long Beach, CA (US)

(73) Assignee: WAMCO, INC., Fountain Valley, CA (US)

(21) Appl. No.: 13/451,866

(22) Filed: Apr. 20, 2012

(51) Int. Cl. G02C 7/10; B32B 37/14; B05D 5/06

(52) U.S. Cl. 351/159.57; 351/159.62; 427/164; 156/278

(57) ABSTRACT

The present disclosure is directed to a thermoplastic laser protective eyewear, and methods of manufacturing said thermoplastic laser protective eyewear. In one embodiment, the laser protective eyewear transmits energy in the visible region and absorbs or reflects energy at peak wavelengths that correspond to commercially available industrial, military and medical lasers.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

This invention relates to laser protective eyewear for military, medical and industrial applications, and methods of manufacturing the same. The laser protective eyewear is capable of transmitting energy in the visible region and absorbing or reflecting energy at specific peak wavelengths. Furthermore, the laser protective eyewear can be manufactured by transferring or laminating one or more inorganic thin film optical coatings onto a polymeric base lens.

2. Description of Related Art

Lasers have become important tools in industrial, medical and military applications. Applications range from laser cutting, to medical surgery, to targeting signals. Typical industrial lasers include but are not limited to Argon (operation wavelengths at 488 and 515 nm), YAG doubled KTP (operation wavelength at 532 nm), Ruby (operation wavelength at 694 nm), Alexandrite (operation wavelengths at700 to 820 nm), Diode (operation wavelength at 810 nm), Ga:As (operation wavelength at 850 to 900 nm), Ti:sapphire (operation wavelength at 680 to 1110 nm), and Nd:YAG (operation wavelength at 1064 nm).

Lasers, if operated without the use of laser protective eyewear (LPE) or a laser protective window, can cause permanent damage to the human eye. More particularly, lasers operating at certain wavelengths and energy levels can cause permanent eye damage and even blindness, depending on exposure and intensity (e.g., wavelengths from 180-315 nm can cause inflammation of the cornea, wavelengths from 315-400 nm can cause photochemical cataract, wavelengths from 400-780 nm can cause photochemical damage to the retina, and wavelengths from 780-1400 nm can cause cataract and retinal damage).

Current technology allows LPEs to be manufactured from glass or from injection molded polymer. Glass based LPEs have certain undesirable limitations, such as increased weight, reduced impact resistance and higher manufacturing costs. However, one advantage of glass eyewear is its ability to serve as a base substrate for high temperature thin film optical coatings using physical vapor deposition or ion assisted vapor deposition. Thin film optical coatings, because of their ability to have sharp optical transitions (unlike absorptive dyes), can be tuned to absorb or reflect specific narrow bands of light without significantly limiting the visible light transmission.

Polymeric laser protective eyewear is predominately manufactured using an optical thermoplastic such as nylon or polycarbonate. Polymeric LPEs have superior impact resistance, low weight, and lower manufacturing costs. However, while current polymeric laser filtering technology allows operators to be protected from harmful laser radiation, it greatly limits visible light transmission. Furthermore, with the current available technology, a user operating multiple laser types must purchase multiple pairs of LPEs to reflect the different operating wavelengths. Current polymeric LPEs that protect against multiple laser wavelengths have greatly reduced visible light transmissions.

Thus, a need still exists in the art for LPEs that are light, that provide high visible transmission, and that provide multi-wavelength rejection bands corresponding to peak laser wavelengths.

### BRIEF SUMMARY OF THE INVENTION

The present disclosure is directed to a series of laser protective eyewear that transmit energy in the visible region and absorb or reflect energy at specific peak wavelengths. In one embodiment, the laser protective eyewear includes a polymeric base lens coated with one or more inorganic thin film optical coatings.

Furthermore, the present disclosure is directed to methods of manufacturing laser protective eyewear that transmit energy in the visible region and absorb or reflect energy at specific peak wavelengths. For example, in one embodiment, the laser protective eyewear is manufactured by applying one or more inorganic thin film optical coatings to a polymeric base lens. The one or more inorganic thin film optical coatings can be applied directly to the polymeric base lens, or indirectly via a transfer lens. Furthermore, in one embodiment of the present invention, the eyewear is manufactured to further include absorptive dye technology.

### BRIEF DESCRIPTION OF SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown.

In the drawings:

FIG. 1 illustrates a polymeric base lens.

FIG. 2 illustrates a laser protective lens manufactured in accordance with the teachings of the present invention.

FIG. 3 is a graph of the emission spectrum in accordance with an embodiment of the present invention.

FIG. 4 depicts a construction of one embodiment of the disclosed laser protective eyewear manufactured in accordance with the teachings of the present invention.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. It should be understood that any one of the features of the invention may be used separately or in combination with other features. Other systems, methods, features, and advantages of the invention will be or become apparent to one with skill in the art upon examination of the drawings and the detailed description. It is intended that all such additional systems, methods, features, and advantages be included within this description, be within the scope of the present invention, and be protected by the accompanying claims.

The present disclosure is directed to a series of laser protective eyewear (LPE) that selectively transmit energy in the visible region of the electromagnetic spectrum (e.g., between 400 and 780 nm) and that have selective absorption in the visible and near infrared regions of the electromagnetic spectrum (e.g., between 780 and 2000 nm). In one embodiment of the present invention, a series of novel polycarbonate laser eyewear have been developed that meet ANSI Z87.1 and Z136.7 for laser compliance. The eyewear is manufactured by applying on or more inorganic thin film optical coatings onto a polymeric base lens. In one embodiment, the base substrate of the polymeric lens is manufactured into an optical lens by injection molding.

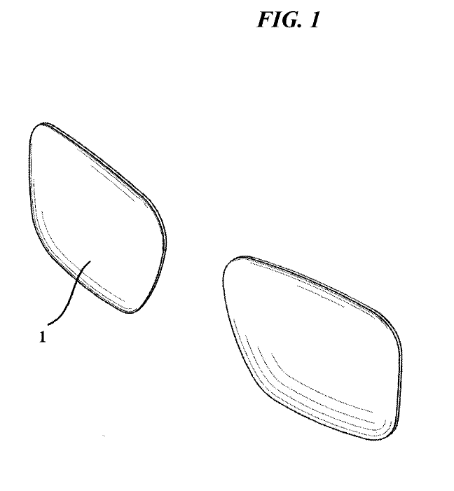

In a further embodiment, as illustrated in FIG. 1, a molded base lens 1 comprises a transparent polymer such as poly (methyl methacrylate) (PMMA), polystyrene, nylon, SAN, polyester, polyimide, polyepoxide, polyetherimide, polycarbonate or a polycarbonate copolymer. In one preferred embodiment, the base substrate of the polymeric lens is a transparent thermoplastic resin, such as, but not limited to, PMMA, polystyrene, nylon, SAN, polyester, polycarbonate or a polycarbonate copolymer.

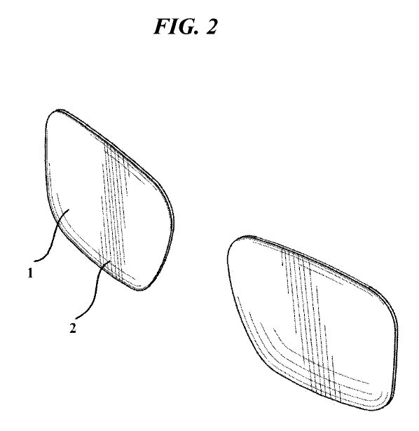

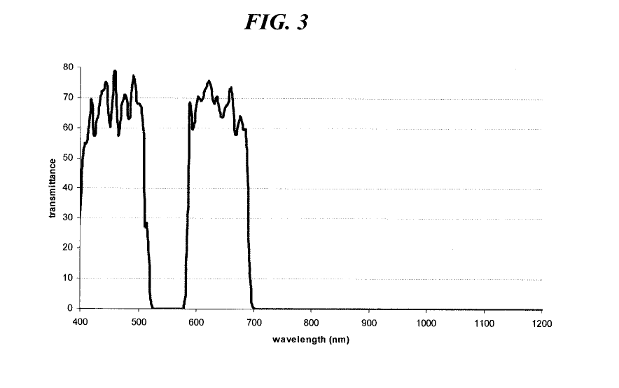

In a preferred embodiment, as illustrated in FIG. 2, the polymeric lens 1 is coated with an inorganic thin film optical coating 2. FIG. 3 depicts the transmittance and absorbance of an inorganic thin film optical coating 2 that is an exemplary embodiment of the present disclosure. The thin film optical coating 2 exhibits high reflection in the red and near infrared regions of the electromagnetic spectrum. In at least one embodiment, the optical thin film coating 2 has a rejection band between approximately 532-580 nm and 700-1200 nm, and a transmission band between approximately 400-510 nm and 580-700 nm.

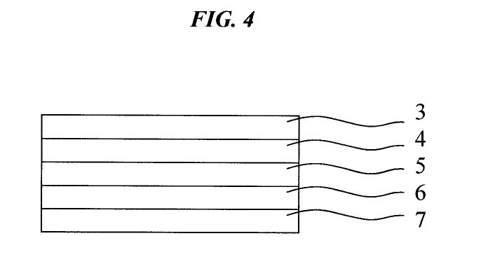

FIG. 4 depicts another embodiment of the disclosed laser protective eyewear manufactured in accordance with the teachings of the present invention. In this embodiment, the eyewear comprises a base polymeric lens 7 coated with an inorganic thin film optical coating 6. The base polymeric lens 7 and inorganic thin film optical coating 6 are further coated by an optically clear encapsulant resin 5. The optically clear encapsulant resin 5 can comprise any optically transparent polymers known in the art such as, but not limited to, transparent polyester, polyurethane, polyepoxide, poly(methyl methacrylate) (PMMA), or silicone. A second inorganic thin film optical coating 4 coats the optically clear encapsulant resin 5. In one embodiment, the eyewear comprises multiple alternating layers of optically clear encapsulant resin and inorganic thin film optical coatings determined by a desired optical performance. Further, in some embodiments, an optically clear anti-scratch hardcoat 3 is the final coating of the LPE. The optically clear anti-scratch hardcoat 3 can comprise any optically transparent polymers known in the art such as, but not limited to, transparent polyester, polyurethane, polyepoxide, poly(methyl methacrylate) (PMMA), or silicone. In another embodiment, the resin encapsulants are cured using any method known in the art, such as thermal or ultraviolet (UV) curing.

In a further embodiment of the invention, the laser protective eyewear is manufactured by alternating optically clear encapsulant resins and inorganic thin film optical coatings until a desired optical performance is achieved. This interlayer stacking process avoids the complications associated with the internal stress and optical requirements of a multi-coating or multiple waveband optical thin film coating stack. Otherwise, a complex multiple layer thin film optical filter stack has an internal stress that is capable of bending a sheet of polymer or even glass, which can change the base curve of the resin lens. Furthermore, multiple rejection bands cannot be achieved in a single layer.

In another embodiment of the present invention, the laser protective eyewear is manufactured by laminating together multiple polymeric lenses. For example, each lens 1 is coated with an inorganic thin film optical coating 2, as shown in FIG. 2. The individual coated lenses are laminated together using an optically clear resin. The optically clear resin can comprise any optically transparent polymers known in the art such as, but not limited to, transparent polyester, polyurethane, polyepoxide, poly(methyl methacrylate) (PMMA), or silicone. Again, the lamination of separately coated lenses avoids the complications associated with the internal stress and optical requirements of a multi-coating or multiple waveband optical thin film coating stack.

In another embodiment of the present invention, the eyewear is manufactured by first applying the thin film optical coating 6 to a glass lens having the substantially same base curve as the base polymer lens 7, and then transferring and bonding the inorganic thin film optical coating 6 onto the polymeric base lens 7. Alternatively, in another embodiment of the present invention, the eyewear lens is manufactured by first applying the thin film optical coating 6 to a transfer lens having the substantially same curvature as the base polymer lens 7, and then transferring and bonding the thin film optical coating 6 onto the polymeric base lens 7. Furthermore, a release agent coating may be applied to the transfer lens prior to applying the inorganic thin film optical coating 6. These transfer methods avoid the complications associated with the internal stress and optical requirements of a multi-coating or multiple waveband optical thin film coating stack.

In another embodiment of the present invention, inorganic thin film optical coatings, such as dichroic coatings, are applied via physical vapor deposition or ion assisted vapor deposition. These coatings are applied at temperatures ranging from approximately 200° C. to 300° C.; however, a standard thermoplastic polymer cannot be processed at these temperatures. Thus, first, the inorganic thin film optical coating is applied to a transfer lens. A release agent coating is applied to the transfer base lens before application of the inorganic thin film optical coating. The transfer lens acts as a temporary carrier for the coating and can be comprised of glass, ceramics, silicon wafer, or other materials with high temperature stability. Furthermore, the inorganic thin film optical coating is designed to be readily removable from the transfer lens.

After applying the inorganic thin film optical coating to the transfer lens, an optical adhesive is applied to the surface of the thin film optical coating. In one embodiment, the adhesive is partially cured, and then the optical coating and adhesive is transferred to the molded polymeric base lens. In another embodiment, the optical coating and adhesive are transferred to the polymeric base lens prior to curing, and then the adhesive is subsequently cured. Upon completion of the curing procedure, the transfer lens is easily removed and the thin film optical coating is transferred to the polymeric base lens. The transfer method can be carried out using an optical hot melt adhesive or liquid adhesive. The result is a polycarbonate LPE with at least one thin film optical coating. This method can be repeated so that the LPE comprises multiple alternating inorganic thin film optical coatings and optical adhesive layers as determined by a desired optical performance. In a further embodiment, the LPE is coated with an abrasion and chemically resistant hardcoat.

In one embodiment of the present invention, the LPE is manufactured by applying one or more inorganic thin film optical coatings directly onto the base substrate lens using physical vapor deposition or ion assisted vapor deposition. Physical vapor deposition and ion assisted vapor deposition optical coatings are applied from approximately 200° C. to 300° C.; however, a standard thermoplastic polymer cannot be processed at these temperatures. Therefore, to apply the optical coating directly onto the polymeric base lens, the polymer base lens should comprise a polymer with a vicat softening temperature above 200° C. Examples of such polymer families include polyimides, polyetherimides, polyepoxides, and polycarbonate copolymers.

In another embodiment of the present invention, the LPE is manufactured by applying one or more inorganic thin film optical coatings directly onto the base substrate lens using sputtering deposition or other coating techniques. Sputtering deposition, or other coating techniques with a sustained chamber temperature below 150° C., can be used to manufacture polymeric base lenses comprised of polymers with a vicat softening temperature below 150° C. Furthermore, using temperatures below 150° C. can allow for either a direct or transferred coating technique.

In another embodiment, inorganic or organic near IR suppressing dyes and pigments are incorporated into the polymer matrix of the thermoplastic eyewear before applying the inorganic thin film optical coating. In one embodiment of the present invention, additional visible dyes or pigments are added to absorb visible laser wavelengths, such as wavelengths at 532 nm and 690 nm. These visible dyes or pigments are added to control the chromaticity and visible radiation of the laser. Also, UV absorbers can be added so that the LPE absorbs in the ultraviolet region of the electromagnet spectrum (e.g. between 200 to 400 nm). The added dyes or pigments should exhibit a high absorbance in the radiation band of the laser and preferably low absorption in the visible region. In one embodiment of the present invention, the IR absorbers need to be purified to 99% purity to limit unwanted absorption. The absorbers are purified using recrystallization, column chromatography, or other purification techniques known to those killed in the art. Otherwise, if the purification is not fully completed, the absorbers exhibit reduced thermal stability. The final strength of the near IR absorption of the laser eyewear depends on the absorbance of the near IR dye or pigment, the purity of the absorber, the thickness of the window, and it's compatibility in the host resin. Common families of absorbers include, but are not limited to, metal dithiolenes, rylenes, porphyrins, tris amminium, phthalocyanines and naphthalocyanines. Phthalocyanines and naphthalocyanines are of particular benefit due to their thermal stability. Phthalocyanine dyes are light stable, exhibit excellent heat resistance, excel in the ability to absorb near infrared energy, and are compatible with multiple resin families. Mixtures of more than one absorber can be used to achieve broad absorption in the near infrared region. Optimization of the mixtures is known to those persons skilled in the art.

It will be appreciated by those skilled in the art that changes could be made to the embodiments described above without departing from the broad inventive concept thereof. It is understood, therefore, that the invention disclosed herein is not limited to the particular embodiments disclosed, but it is intended to cover modifications within the spirit and scope of the present invention as defined by the appended claims.

What is claimed is:

1. A laser protective eyewear comprising:
a polymeric base lens;
said polymeric base lens coated with one or more inorganic thin film optical coatings.

2. The laser protective eyewear of claim 1, wherein the laser protective eyewear selectively transmits energy in the visible region of the electromagnetic spectrum and selectively absorbs energy in the visible and near infrared regions of the electromagnetic spectrum.

3. The laser protective eyewear of claim 1, wherein the polymeric base lens comprises one or more of the following: poly(methyl methacrylate) (PMMA), polystyrene, nylon, SAN, polyester, polyimide, polyepoxide, polyetherimide, polycarbonate, or a polycarbonate copolymer.

4. The laser protective eyewear of claim 1, wherein an optically clear encapsulant resin is bonded between alternating layers of the one or more inorganic thin film optical coatings.

5. The laser protective eyewear of claim 4, wherein the optically clear encapsulant resin comprises one or more of the following: transparent polyester, polyurethane, polyepoxide, poly(methyl methacrylate) (PMMA), or silicone.

6. The laser protective eyewear of claim 1, further comprising an optically clear anti-scratch hardcoat.

7. The laser protective eyewear of claim 6, wherein the optically clear anti-scratch hardcoat comprises one or more of the following: transparent polyester, polyurethane, polyepoxide, poly(methyl methacrylate) (PMMA), or silicone.

8. A method of manufacturing a laser protective eyewear, comprising:
coating a polymeric base lens with one or more inorganic thin film optical coatings.

9. The method of claim 8, wherein the laser protective eyewear is manufactured by laminating together multiple polymeric base lenses.

10. The method of claim 8, wherein the laser protective eyewear selectively transmits energy in the visible region of the electromagnetic spectrum and selectively absorbs energy in the visible and near infrared regions of the electromagnetic spectrum

11. The method of claim 8, further comprising coating each of the one or more inorganic thin film optical coatings with an optically clear encapsulant resin.

12. The method of claim 8, further comprising coating the polymeric base lens with one or more inorganic thin film optical coatings until a desired optical performance is achieved.

13. The method of claim 12, further comprising bonding an optically clear encapsulant resin between alternating layers of the one or more inorganic thin film optical coatings.

14. The method of claim 8, wherein the one or more inorganic thin film optical coatings are applied to the polymeric base lens via physical vapor deposition, ion assisted vapor deposition, or sputtering deposition.

15. The method of claim 8, wherein one or more of the following dyes or pigments are incorporated into the polymeric base lens: inorganic or organic near infrared suppressing dyes or pigments, UV absorbers, or dyes or pigments that absorb visible laser wavelengths.

16. A method of manufacturing a laser protective eyewear, comprising:
applying an inorganic thin film optical coating to a transfer lens;
transferring said inorganic thin film optical coating from the transfer lens to a polymeric base lens; and
bonding said inorganic thin film optical coating to the polymeric base lens.

17. The method of claim 16, wherein the transfer lens has the substantially same curvature as the polymeric base lens.

18. The method of claim 16, wherein a release agent coating is applied to the transfer lens prior to applying the inorganic thin film coating to the transfer lens.

19. The method of claim 16, wherein the inorganic thin film optical coating is applied via physical vapor deposition or ion assisted vapor deposition.

20. The method of claim 16, wherein the transfer lens is comprised of one of the following: glass, ceramics, silicon wafer, or other materials with high temperature stability.

21. The method of claim 16, wherein the inorganic thin film optical coating and polymeric base lens are secured via an optical adhesive.

22. The method of claim 16, wherein one or more of the following dyes or pigments are incorporated into the polymeric base lens: inorganic or organic near infrared suppressing dyes or pigments, UV absorbers, or dyes or pigments that absorb certain visible laser wavelengths.

23. The method of claim 16, further comprising applying one or more inorganic thin film optical coatings to the polymer base lens until a desired optical performance is achieved.
